(19) United States
(12) Patent Application Publication
(10) Pub. No.: US 2008/0010482 A1
(43) Pub. Date: Jan. 10, 2008

(54) Remote control of a media computing device

(75) Inventor: Michael Hin-cheung Tsang, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/451,818

(22) Filed: Jun. 13, 2006

(51) Int. Cl. G06F 11/00

(52) U.S. Cl. 714/2

(57) ABSTRACT

A remote control of a media computing device is provided. A communication port or device of the media computing device receives an input from a remote receiver or a remote application. The command is parsed and translated into an HID event and the translated HID event is provided to a virtual control driver module. The virtual control driver module provides the translated HID event to a media application resident on the media computing device via an input device module as if the HID event had been received from a local HID of the media computing device. In one implementation, for example, a remote receiver allows remote control of a media computing device. In another implementation, a remote application provides commands to the media computing device.

### BACKGROUND

Many home entertainment networks allow media that is accessible by a computer to be presented by more traditional video and audio output devices. For example, movies or music recorded on a computer's hard disk can be directed via a media application to a television or stereo amplifier for playback. Furthermore, the computer can often control various aspects of the video and audio output devices, such as equalizer settings, channel settings, input features, and other configuration settings.

A user can manipulate the computer to direct this output and to control the output devices via the computer's human interface devices (HIDs). An HID is a type of computer device that interacts directly with and takes input from humans, such as a keyboard or a mouse. The computer, however, is often located separately from the visual and/or audio output devices controlled by the computer. Thus, the traditional HIDs of the computer may not be convenient for controlling the operation of the home entertainment network.

### SUMMARY

Implementations described and claimed herein address the foregoing problems by providing alternative channels for controlling aspects of a home entertainment network. An injection process supports receipt of input control commands by a remote receiver (e.g., via a serial port) or a remote application (e.g., via a network interface). A remote command processor module receives input command signals via input channels, such as a serial port interface or network interface and operates to parse and translate the commands into events and inject the translated events into a virtual control driver component of an HID module. The injected events are then sent by the HID module to appropriate input device modules for input to a media application that is resident on a media computing device. Through such a configuration, the injected events can control the media application and associated media input and output devices as though the events were received from a traditional local HID device, rather than as commands from a remote channel (e.g., serial port, parallel port, network adapter, etc.).

In some implementations, articles of manufacture are provided as computer program products. One implementation of a computer program product provides a computer program storage medium readable by a computer system and encoding a computer program. Another implementation of a computer program product may be provided in a computer data signal embodied in a carrier wave by a computing system and encoding the computer program. Other implementations are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

FIG. 1 illustrates an example home entertainment environment.

FIG. 2 illustrates an example configuration for providing commands to a media application.

FIG. 3 illustrates example operations for providing a remote control input for a media computing device.

FIG. 4 is a schematic diagram of a general purpose computing system for implementing aspects of the home entertainment environment.

### DETAILED DESCRIPTION

Remote control of a media computing device allows a user to control aspects of a home entertainment network via remote channels, rather than traditional local HID components of the media computing device. Input control commands can be received by a remote receiver (e.g., via a serial port) or a remote application (e.g., via a network interface). A remote command processor module receives input command signals via input channels, such as a serial port interface or network interface and operates to parse and translate the commands into HID events and inject the translated HID events into a virtual control driver component of an HID module. The injected HID events are then sent by the HID module to appropriate input device modules for input to a media application that is resident on a media computing device. Through such a configuration, the injected HID events can control the media application and associated media input and output devices as though the HID events were received from a traditional local HID device, rather than as commands from a remote channel (e.g., serial port, parallel port, network adapter, etc.).

In one implementation, for example, a remote receiver allows remote control of a media computing device by receiving a control command in an input control signal and communicating the input control signal to a serial port of the media computing device. The input control signal is passed into a driver stack of the serial port. A remote command processor module parses and translates the command from the input control signal into an HID event and forwards the translated HID event to a virtual control driver component of an HID module. The virtual control driver component, in turn, provides the translated HID event to an input device module that provides the translated HID event to the media application as if it were received from a local HID of the media computing device. Other uses and implementations are contemplated.

In another implementation, a remote application provides control commands to the media computing device. A remote computing system can execute the remote application in communication with the media computing device, such as via a communications network. The remote application, for example, may regression test and/or stress test the media computing device by providing a sequence of control commands (in an input control signal) defined to determine whether the media computing device is functioning correctly. The received input control signal is passed into a driver stack of the network interface. A remote command processor module parses and translates a control command from the input control signal into an HID event and forwards the translated HID event to a virtual control driver component of an HID module. The virtual control driver component, in turn, provides the translated HID event to an input device module that provides the translated HID event to the media application as if it were received from a local HID of the media computing device. In this manner, automated testing of the media computing device may be performed without requiring manual data entry of commands. Other uses and implementations are contemplated.

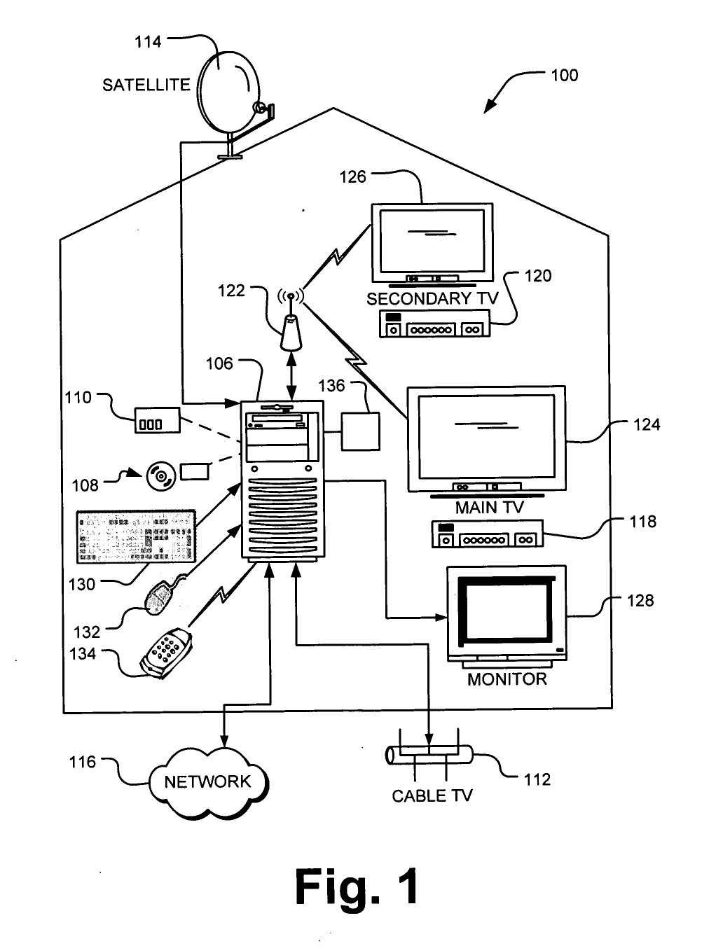

FIG. 1 depicts an example home entertainment environment 100 including a media computing device 106, such as a media server. In one implementation, for example, the media computing device 106 includes a conventional personal computer (PC) configured to run a multimedia software package, for example, the WINDOWS® XP Media Center Edition operating system (Microsoft Corporation, Redmond Wash.). In such a configuration, the media computing device 106 is able to integrate full computing functionality with a complete home entertainment system into a single PC. For example, a user can watch television (TV) in one graphical window of a video monitor while sending email or working on a spreadsheet in another graphical window on the same monitor. In addition, the home entertainment system may also include other features, for example: a personal video recorder (PVR) to capture live TV shows for future viewing or to record the future broadcast of a single program or series; compact disc (CD) or digital video disc (DVD) drive 108; an integrated or remote storage device, such as a hard drive 110, and an electronic program guide (EPG). The drive 108 or drive 110 may be used, for example, for storing and/or accessing a user's recorded content, such as TV shows, songs, pictures, and home videos.

Alternatively to a conventional PC, the media computing device 106 may includes a variety of other devices capable of rendering a media component including, for example, a notebook or portable computer, a tablet PC, a workstation, a mainframe computer, a server, an Internet appliance, or combinations thereof. The media computing device 106 may also be a set-top box capable of delivering media content to a computer where it may be streamed. Alternatively, the set-top box itself could stream the media content. As the media computing device 106 may be a full function computer running an operating system, the user may also have the option to run standard computer programs (e.g., word processing and spreadsheets), send and receive emails, browse the Internet, or perform other common functions.

In addition to storing media content, the media computing device 106 may be connected with a variety of media sources, for example, a cable connection 112, a satellite receiver 114, an antenna (not shown for the sake of graphic clarity), and/or a communications network 116, such as the Internet. A user may thus control a live stream of media content (e.g., TV content) received, for example, via the cable connection 112, the satellite receiver 114, antenna, or the communications network 116. This capability is enabled by one or more tuners residing in the media computing device 106. The one or more tuners may alternatively or additionally be located remotely from the media computing device 106. In either case, the user may choose a tuner to fit any particular set of preferences. For example, a user wishing to watch both standard definition (SD) and high definition (HD) content may employ a tuner configured for both types of contents. Alternately, the user may employ an SD tuner for SD content and an HD tuner for HD content separately.

The TV content may be received as an analog (i.e., radio frequency) signal or a digital signal (e.g., digital cable or digital satellite signal). The received TV content may include discrete content packets, wherein each content packet includes actual TV content (i.e., audio and video data) and a policy or policies associated with the actual TV content. If TV content is received as an analog signal, discrete content packets may be created from the analog signal.

The home environment 100 may also include one or more media receivers or home network devices 118 and 120 placed in communication with the media computing device 106 through a network 122, for example, a local area network (LAN). In an example embodiment, the home network device 118 may be a Media Center Extender device, for example, an XBOX® 360 system (Microsoft Corporation, Redmond, Wash.). The home network devices 118 and 120 may also be implemented as any of a variety of conventional computing devices, including, for example, a set-top box, a television, a gaming console, a desktop PC, a notebook or portable computer, a workstation, a mainframe computer, an Internet appliance, a handheld PC, a cellular telephone or other wireless communications device, a personal digital assistant (PDA), or combinations thereof. Furthermore, the home network devices 118 and 120 may include tuners as described above.

The network 122 may includes a wired and/or wireless network, for example, cable, Ethernet, WiFi, a wireless access point (WAP), or any other electronic coupling means, including the Internet. The network 122 may enable communication between the media computing device 106, the home network devices 118 and 120, and any other connected device through packet-based communication protocols, such as transmission control protocol (TCP), Internet protocol (IP), real time transport protocol (RTP), and real time transport control protocol (RTCP). Communications may be transmitted directly between devices over a LAN, or they may be carried over a wide area network (WAN), for example, the Internet 116.

One or more video display devices, for example, a main TV 124 in a living room, a secondary TV 126 in a bedroom, and a video monitor 128 may be situated throughout the home environment 100. These video display devices may be connected with the media computing device 106 via the network 122 either directly or via the home network devices 118 and 120. The main TV 124 and the secondary TV 126 may be coupled to the home network devices 118 and 120 through wireless means or conventional cables. The video monitor 128 may be coupled with the media computing device 106 directly via a video cable. Media content including TV content may thus be supplied to each of the video display devices 124, 126, and 128 over the home network 122 from the media computing device 106 situated in one room of a house.

The home network devices 118 and 120 may be configured to receive streamed media content, including video and TV content, from the media computing device 106. Media content, and particularly video and TV content, may be transmitted from the media computing device 106 to the home network devices 118 and 120 as streaming media including discrete content packets via any of the network protocols described above. The streamed media content may include video IP, SD, and HD content, including video, audio, and image files, decoded on the home network devices 118 and 120 for presentation on the connected TVs 124 and 126. The media content may further be “mixed” with additional content, for example, an EPG, presentation content related to the media content, a web browser window, and other user interface environments transmitted from the media computing device 106 for output on the TVs 124, 126 or the monitor 128. Such additional media content may be delivered in a variety of ways using different protocols, including, for example, standard remote desktop protocol (RDP), graphics device interface (GDI), or hyper text markup language (HTML).

In addition to the home network devices 118 and 120 and the video display devices 124, 126, 128, the media computing device 106 may be communicatively coupled with other peripheral devices, including components such as digital video recorders (DVR), cable or satellite set-top boxes, speakers, and a printer (not shown for the sake of graphic clarity). The media computing device 106 may also enable multi-channel output for speakers. This may be accomplished through the use of digital interconnect outputs, such as Sony-Philips Digital Interface Format (S/PDIF) or TOSLINK® enabling the delivery of Dolby Digital, Digital Theater Sound (DTS), or Pulse Code Modulation (PCM) surround decoding.

The media computing device 106 further includes at least one HID, such as a keyboard 130, a mouse 132, and/or an infrared remote control device 134, for controlling the operation of the media computing device 106. The media computing device further includes an alternative input channel, such as remote receiver 136 or a network interface 122, for receiving remote control commands. The alternative input channel may include, for example, a serial port, a universal serial bus (USB) port, a firewire port, an IEEE 1394 port, a parallel port, a network card, or the like. As described below, the alternative input channel is configured to receive remote control commands for controlling operation of the media computing device 106 or another device in the home entertainment environment 100.

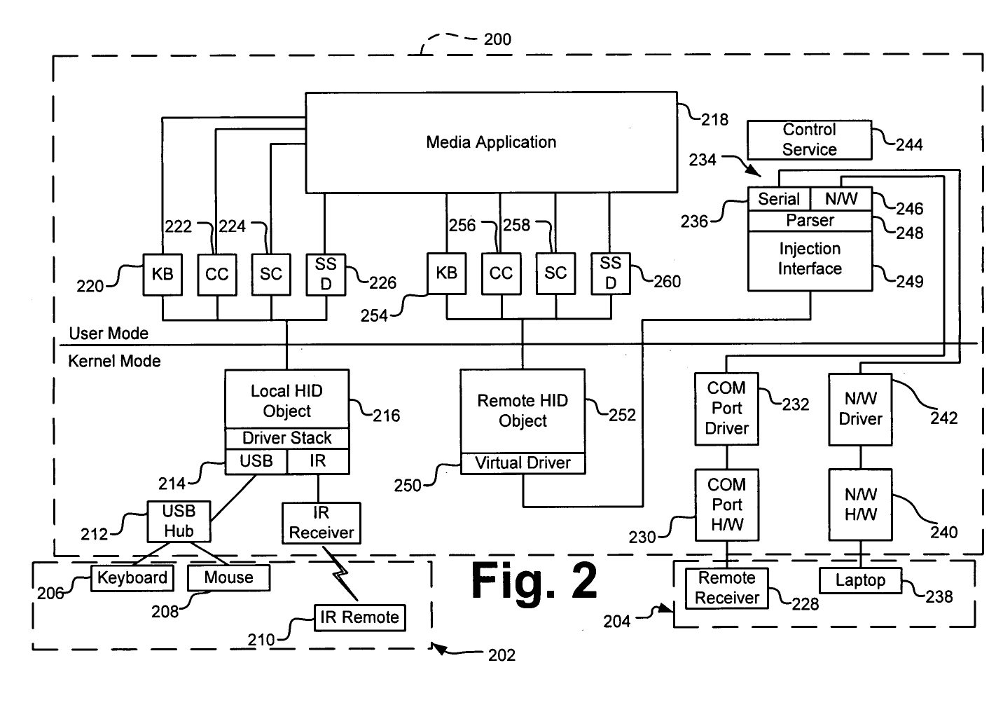

FIG. 2 illustrates an example configuration for providing commands to a media application. The illustrated configuration provides a local HID driver object for processing input HID events received from traditional local HID components, such as a keyboard, a mouse, or an infrared remote control device. The illustrated configuration also provides a virtual remote HID driver object that receives injected commands from a remote control device through an alternative input channel and presents itself to the media computing device 200 as a local HID driver object through one or more input device modules. The media computing device 200 can thus receive input control commands from both local HIDs 202 and remote control devices 204.

In the implementation shown in FIG. 2, for example, the media computing device 200 interfaces with local HIDs 202 including a keyboard 206, a mouse 208, and an infrared remote control device 210 and remote control devices 204. The keyboard 206 and the mouse 208 include universal serial bus (USB) devices that are wirelessly connected or attached to a USB hub 212 and/or port of the media computing device 200. Other input devices and communication methods may be used. HID events received from the keyboard 206 and the mouse 208 are received by a USB driver 214 (e.g., a human interface device (HID) driver corresponding to the USB interface HID_USB.sys) via the USB hub 212. The USB driver 214 parses the HID events received via the USB hub 212, and the local HID object 216 forwards the parsed control commands to the media control application 218 via an input device module (e.g., an operating system object) corresponding to the source of the command. In the particular implementation shown in FIG. 2, for example, four categories of HID usages correspond to HID events received from the local HIDs 202: (1) a keyboard HID usage corresponding to keyboard and/or keypad inputs from the keyboard 206 and/or the infrared remote control device 210, such as keystrokes (e.g., A-Z, a-z, 0-9, “Enter,” “Tab,” “Backspace,” “Caps Lock,” “Ctrl,” “Alt,” symbols, and the like), and inputs from the mouse 208 will be provided to a keyboard input device module 220, (2) a consumer control HID usage corresponding to consumer control inputs, such as “Channel Up,” “Channel Down,” Volume Up,” “Volume Down,” “Mute,” “Play,” “Pause,” “Stop,” “Fast Forward,” “Rewind,” “Record,” and the like, will be provided to a consumer control input device module 222, (3) a system control HID usage corresponding to system control inputs, such as a sleep or standby command, will be provided to a system control input device module 224, or (4) a system-specific HID usage corresponding to an input from the infrared remote control device 210, such as “My TV,” “My Videos,” “My Music,” “My Pictures,” “Recorded TV,” and the like, will be provided to a system-specific input device module 226. The input device modules 220, 222, 224, and 226 then provide the corresponding inputs to the media control application 218. Other categories of HID usages, however, may be used.

The media computing device 200 also interfaces with remote control devices 204, such as a remote receiver 228 and/or a laptop 238. The media computing device 200 presents an input from the remote control devices 204 to the media control application 218. A remote control device 204 may be used, for example, to control the media computing device 200 remotely or simulate at least one of local HIDs 202 and provide for automated testing of the commands to be stored on the local HIDs 202.

In one particular implementation, for example, commands received via the remote control devices 204 are presented to the media control application 218. Thus, commands may be sent from such a device to the media computing device 200 even though the device is out of range of an actual infrared remote control device 210. In this implementation, a remote receiver 228 is connected to the media computing device 200 via a serial communication port (e.g., an RS 232 serial COM port), although other types of remote control devices and/or communication methods may be used. The remote receiver 228 is connected to the serial port hardware 230 of the media computing device 200 and communicates with the media computing device 200 via the serial interface. The serial port hardware 230, in turn, communicates with a serial driver stack 232 (e.g., an RS232 driver, such as serial.sys) that receives signals from the hardware interface and translates them into commands. The commands from the serial driver stack 232 are communicated to a remote command processor module 234 via a serial input interface 236.

Similarly, a network device, such as a laptop 238 is connected to the media computing device 200 via a network interface (e.g., a wired communication network, such as a LAN, or a wireless communication network, such as a WiFi network). In one implementation, for example, a wireless communication network, such as an 802.11 wireless network may be used to connect the laptop 238 to the media computing device 200, although other types of remote control devices and/or communication methods may be used. The laptop 238 is connected to network hardware 240 of the media computing device 200 and communicates with the media computing device 200 via the network. The network hardware 240, in turn, communicates with a network driver stack 242 that receives signals from the network hardware interface and translates them into commands. The commands from the network driver stack 242 are communicated to the remote command processor module 234 via a network input interface 246. A control service 244 provides a container for loading one or more DLL for the remote command processor module 234, such as the serial input interface 236, the network input interface 246, a command parser layer 248, and an injection interface module 249.

The commands received by the serial input interface 236 and the network input interface 246 of the injection interface module 234 are parsed and translated into HID events by the command parser layer 248 of the remote command processor module 234. The translated HID events are then forwarded to a virtual control driver component 250 (e.g., VHIDMCE.sys) of a remote HID object 252 by the injection interface module 249. The virtual control driver component 250 forwards the HID events received via the injection interface module 234, and the remote HID object 252 routes the HID events to the media control application 218 via an input control device corresponding to the simulated source of the command, such as a keyboard input control device 254, a consumer control input control device 256, a system control input control device 258, or a system-specific input control device 260. The input control devices 254, 256, 258, and 260 then provide the corresponding inputs to the media control application 218.

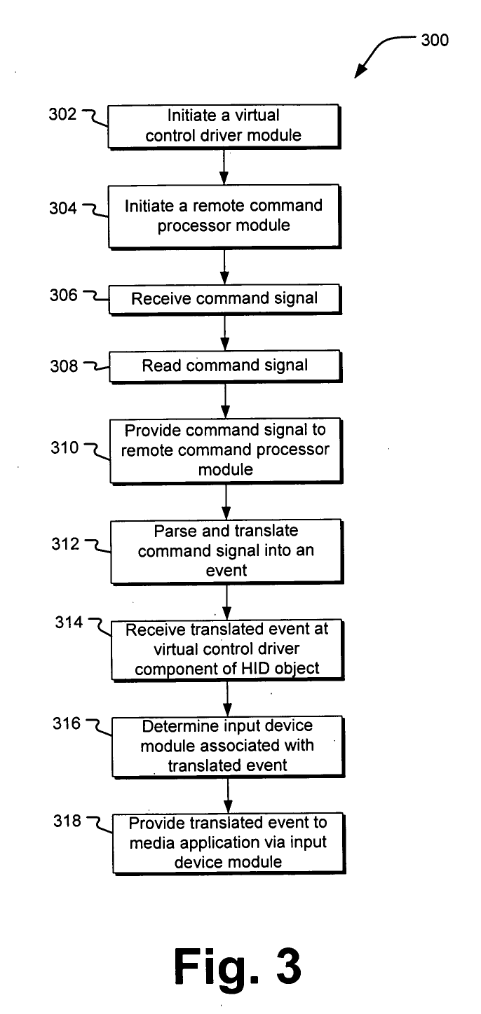

FIG. 3 illustrates example operations 300 for providing a remote control input for a media computing device. A virtual control driver module is initiated at a kernel level in an initiation operation 302. A remote command processor module is also initiated at a user mode level in another initiation operation 304.

A command signal is received from a remote control device at a hardware interface device (e.g., a serial port or network card) in receive operation 306. The command signal may include a single command or a command string including a plurality of commands directed to the media computing device. The command signal (e.g., one or more command string) is read by a driver stack (e.g., an RS232 COM port driver stack or network port driver stack) in read operation 308. The driver stack provides the command signal to the remote command processor module in provide operation 310.

A command parser of the remote command processor module then parses and translates the command to corresponding HID events in translate operation 312. In one particular implementation, for example, the command parser uses a look-up table to determine an HID event corresponding to a usage pair received in the command. In this implementation, the look-up table may provide an HID event corresponding to a keyboard usage page and a particular keystroke HID usage for a particular keystroke made on a keyboard. In another implementation, the command includes an HID usage pair including an HID usage page identifying a class of commands and an HID usage identifying one or more individual command defined within the class. A command simulating a keyboard or keypad keystroke, for example, includes an HID usage page identifying the keyboard class and an HID usage identifying a particular keystroke. A command simulating a consumer control command (e.g., “Play”) includes a consumer control command HID usage page identifying the consumer control class and an HID usage corresponding to the particular consumer control command within that usage page. Similarly, a command simulating a system control command (e.g., “Sleep”) includes a system command usage page identifying the system control class and an HID usage corresponding to the particular system control command within that page, and a command simulating a system-specific device command (e.g., “My TV”) includes a system command usage page identifying the system-specific device class and an HID usage corresponding to the particular system-specific device command within that page.

An injection interface module of the remote command processor module then forwards the translated HID events to a virtual control driver component of a remote HID object. In one implementation, for example, the remote command processor module may receive a command string representing a sequence of commands to be performed at the media computing device or to be passed on to another device in a home entertainment environment. In this implementation, the command parser of the remote command processor module separates and translates the individual commands represented in the command string into HID events. The injection interface module then provides, serially and/or in parallel, the translated HID events to the virtual control driver component of the remote HID object. Where one HID event may require time to operate before the next HID event is received at the virtual control driver component, the injection interface module may provide a delay between forwarding the individual HID events parsed from a command string. The delay may include a standard delay introduced between each HID event forwarded or delays between HID events may be customized for one or more types of HID events depending on actual delays needed by that type of HID event.

The virtual control driver component of the remote HID object receives the translated HID events from the injection interface module in receive operation 314 and determines an input device module associated with a category of the HID event at the remote HID object in determine operation 316. In the implementation described above with respect to FIG. 2, for example, the remote HID object determines whether the HID event is simulating a keyboard usage, a consumer control usage, a system control usage, or a system-specific device usage. Other categories of HID events could be used. The individual commands are then forwarded to a media application as the particular class usages they are simulating in forward operation 318. Thus, a remote command provided by a remote control device is presented to a media application running on the media computing device or another device located in the home entertainment environment.

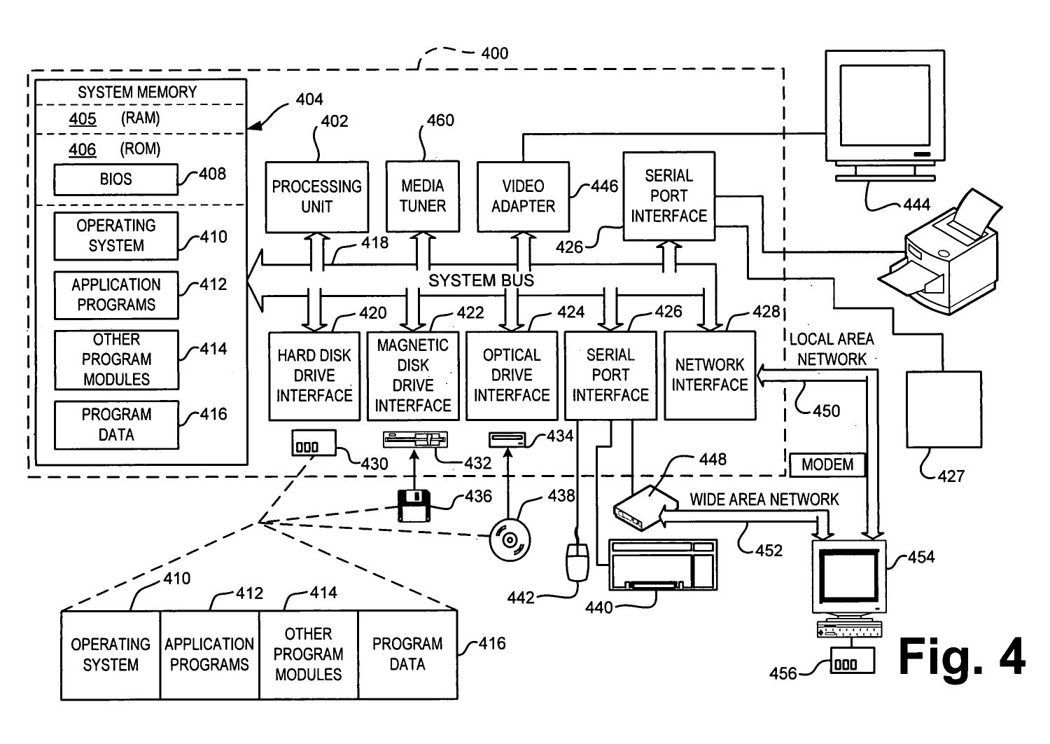

An example hardware and operating environment for implementing a home entertainment environment is depicted in FIG. 4. As indicated above, a media computing device and media receiver devices may comprise general purpose computing devices. A general purpose computing device may be the form of a computer 400, including a processing unit 402, a system memory 404, and a system bus 418 that operatively couples various system components, including the system memory 404 to the processing unit 402. There may be only one or there may be more than one processing unit 402, such that the processor of computer 400 comprises a single central processing unit (CPU), or a plurality of processing units, commonly referred to as a parallel processing environment. The computer 400 may be a conventional computer, a distributed computer, or any other type of computer; the invention is not so limited.

The system bus 418 may be any of several types of bus structures including a memory bus or memory controller, a peripheral bus, a switched fabric, point-to-point connections, and a local bus using any of a variety of bus architectures. The system memory 404 may also be referred to as simply the memory, and includes read only memory (ROM) 406 and random access memory (RAM) 405. A basic input/output system (BIOS) 408, containing the basic routines that help to transfer information between elements within the computer 400, such as during start-up, is stored in ROM 406. The computer 400 further includes a hard disk drive 430 for reading from and writing to a hard disk, not shown, a magnetic disk drive 432 for reading from or writing to a removable magnetic disk 436, and an optical disk drive 434 for reading from or writing to a removable optical disk 438 such as a CD ROM, DVD, or other optical media.

The hard disk drive 430, magnetic disk drive 432, and optical disk drive 434 are connected to the system bus 418 by a hard disk drive interface 420, a magnetic disk drive interface 422, and an optical disk drive interface 424, respectively. The drives and their associated computer-readable media provide nonvolatile storage of computer-readable instructions, data structures, program modules and other data for the computer 400. It should be appreciated by those skilled in the art that any type of computer-readable media that can store data that is accessible by a computer, for example, magnetic cassettes, flash memory cards, digital video disks, RAMs, and ROMs, may be used in the example operating environment.

A number of program modules may be stored on the hard disk 430, magnetic disk 432, optical disk 434, ROM 406, or RAM 405, including an operating system 410, one or more application programs 412, for example, a multimedia software package, other program modules 414, and program data 416, for example, media content. A user may enter commands and information into the personal computer 400 through local HIDs, such as a keyboard 440 and pointing device 442, for example, a mouse. Other local HIDs (not shown) may include, for example, a microphone, a joystick, a game pad, a tablet, a touch screen device, a satellite dish, a scanner, a facsimile machine, a remote control, and a video camera. A remote control device 427 is also connected to the computer 400, such as via the serial port interface 826 as shown in FIG. 4. These and other control devices are often connected to the processing unit 402 through a serial port interface 426 that is coupled to the system bus 418, but may be connected by other interfaces, such as a parallel port, game port, a universal serial bus (USB), a firewire port, an IEEE 1394 port, a network card, a wireless card, an Ethernet port, or the like.

A monitor 444 or other type of display device is also connected to the system bus 418 via an interface, such as a video adapter 446. In addition to the monitor 444, computers typically include other peripheral output devices, such as a printer 458 and speakers (not shown). These and other output devices are often connected to the processing unit 402 through the serial port interface 426 that is coupled to the system bus 418, but may be connected by other interfaces, such as a parallel port, game port, or a universal serial bus (USB). In the case of a media server or other media computing device, a tuner 460 may also be connected with the system bus in order to receive and convert analog content signals into digital format and similarly convert digital content into analog signals for transmission to connected devices.

The computer 400 may operate in a networked environment using logical connections to one or more remote computers, such as remote computer 454. These logical connections may be achieved by a communication device coupled to or integral with the computer 400; the computer is not limited to a particular type of communications device. The remote computer 454 may be another computer, a server, a router, a network personal computer, a client, a peer device, or other common network node, and typically includes many or all of the elements described above relative to the computer 400, although only a memory storage device 456 has been illustrated in FIG. 4. The logical connections depicted in FIG. 4 include a wired or wireless local-area network (LAN) 450, for example, an Ethernet network, or a WiFi network, and a wide-area network (WAN) 452, for example, a cable network or a telephony network. Such networking environments are commonplace in office networks, enterprise-wide computer networks, intranets and the Internet, which are all types of networks.

When used in a LAN 450 environment, the computer 400 may be connected to the local network 450 through a network interface or adapter 428, which is one type of communications device. When used in a WAN 452 environment, the computer 400 typically includes a modem 448, a network adapter, or any other type of communications device for establishing communications over the wide area network 452. The modem 448, which may be internal or external, is connected to the system bus 418 via the serial port interface 426. In a networked environment, program modules depicted relative to the personal computer 400, or portions thereof, may be stored in a remote memory storage device. It is appreciated that the network connections shown are example and other means of and communications devices for establishing a communications link between the computers may be used.

In an example implementation, a remote command processor module, a virtual control driver module, an input device module, and other modules may be embodied by instructions stored in memory 22 and/or storage devices 29 or 31 and processed by the processing unit 21. Command data, injection data, and other data may be stored in memory 22 and/or storage devices 29 or 31 as persistent datastores.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of example embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understand that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

Although the subject matter has been described in language specific to structural features and/or methodological arts, it is to be understood that the subject matter defined in the appended claims is not necessarily limited to the specific features or acts descried above. Rather, the specific features and acts described above are disclosed as example forms of implementing the claimed subject matter.

What is claimed is:

1. A media computing device executing a media application, the media computing device comprising:
a remote command processor module that executes on the media computing device, responsive to input control signals received via at least one remote communications channel, to parse the input control signals received via the at least one remote communications channel and to generate human interface device events based on the input control signals; and
a remote human interface device module that executes on the media computing device, to receive the human interface device events from the injection interface module and to pass the human interface device events to at least one input device module for receipt by the media application.

2. The system of claim 1 further comprising a local human interface device module that executes on the media computing device and receives input human interface device events via at least one local human interface device attached to the media computing device.

3. The system of claim 2 wherein the at least one local HID comprises at least one of a keyboard input, a pointing device input, or an infrared receiver.

4. The system of claim 1 wherein the remote communications channel comprises a remote receiver.

5. The system of claim 4 wherein the remote receiver is connected to the media computing device via a serial port.

6. The system of claim 1 wherein the remote communications channel comprises a network interface.

7. The system of claim 1 wherein the input device module comprises a keyboard input device module.

8. The system of claim 1 wherein the input device module comprises a consumer control input device module.

9. The system of claim 1 wherein the input device module comprises a system control input device module.

10. The system of claim 1 wherein the input device module comprises a system-specific device input device module.

11. The system of claim 1 wherein a control service application controls communication received at the injection interface from the remote control driver module.

12. The system of claim 1 wherein the remote command processor module comprises a user mode level module and the remote human interface device module comprises a kernel level module.

13. The system of claim 1 wherein the remote communications channel provides test data from a remote application resident on a remote computing system.

14. A method for controlling a media computing device, the method comprising:
initiating a virtual control driver module;
initiating a remote command processor module;
receiving a command signal from a remote control device;
translating the command signal to obtain an event at the injection interface module;
determining an input device module for the event at the virtual control driver module; and
providing the event to a media application via the input device module.

15. The method of claim 14 wherein the command signal is received via a remote control driver module.

16. The method of claim 14 wherein the remote control device comprises a remote receiver.

17. The method of claim 14 wherein the remote control device comprises a remote application.

18. The method of claim 14 wherein the translating operation comprises separating commands from a command string and translating the commands into HID events.

19. A computer-readable medium having computer-executable instructions for performing a computer process that implements the operations comprising:
initiating a virtual control driver module;
initiating a remote command processor module;
receiving a command signal from a remote control device;
translating the command signal to obtain and event at the injection interface module;
determining an input device module for the event at the virtual control driver module; and
providing the event to a media application via the input device module.

20. The computer-readable medium of claim 19 wherein the translating operation comprises separating commands from a command string and translating the commands into HID events.
